(19) United States
(12) Patent Application Publication
(10) Pub. No.: US 2009/0295724 A1
(43) Pub. Date: Dec. 3, 2009

(54) Adjustable torque joystick

(76) Inventors: Wen-Feng Cheng, Kaohsiung City (TW); Yaun-Pin Chen, Fongshan County (TW); Cheng-Huan Chen, Kaohsiung City (TW)

Correspondence Address: Daniel J. Deneufbourg, Esq.;CTS Corporation, 171 Covington Drive, Bloomingdale, IL, 60108, US

(21) Appl. No.: 12/454,985

(22) Filed: May 27, 2009

Related U.S. Application Data
(60) Provisional application No. 61/130,110, filed on May 28, 2008.

(51) Int. Cl. G06F 3/033

(52) U.S. Cl. 345/161

(57) ABSTRACT

An adjustable torque joystick control assembly includes a housing and a stick assembly mounted in, and extending from, the housing. A gimbal assembly is coupled to the stick assembly and contained within the housing. A torque or force adjustment assembly is located in the housing above the gimbal assembly and, in one embodiment, includes a spring compression member adapted to exert a force against one end of a spring to compress the spring and cause an opposite end of the spring to exert a force against the gimbal assembly and increase the force required to move the stick assembly.

### CROSS-REFERENCE TO RELATED APPLICATION

This non-provisional application claims the benefit of U.S. Provisional Application Ser. No. 61/130,110 filed on May 28, 2008, the disclosure of which is explicitly incorporated herein by reference as are all references cited therein.

### FIELD OF THE INVENTION

This invention generally relates to a control device, such as a joystick or pointing stick, for controlling the positioning, movement and operation of a responsive electrical device and, more specifically, to a joystick that has a mechanism for varying or adjusting the torque or force required to move the joystick.

### BACKGROUND OF THE INVENTION

Various devices are well known for controlling cursor or pointer movements on a computer or game display screen. Such devices include joysticks, mice, buttons, thumbwheels and touchpads.

A joystick is typically an elongated stick that extends upwardly from a base. The joystick is operated by tilting the upstanding stick in various directions to cause the cursor or other display element to move in a direction and usually at a speed corresponding to the direction and pressure exerted on the stick by the computer operator.

In a majority of the computer games available today, at least two joysticks are mounted on a controller which a player typically holds in his hands. One of the joysticks is held and manipulated by the player to adjust a character's direction while the other joystick is held and manipulated by the player to adjust the character's aim. For some games such, for example, shooting games which include different types of weapons, different types of aiming characteristics are desired. For example, if the weapon is a pistol, quick aiming may be preferred while, if the weapon is a rocket launcher, fine and precise aiming may be preferred.

One of the ways in which either quick aiming or fine and precise aiming can be accomplished is by allowing a player to adjust the torque or force required to move the joystick from, for example, a light torque or force for quick aiming and a heavy torque or force for fine and precise aiming.

The present invention is directed to a new and improved joystick incorporating an adjustable torque or force assembly.

### SUMMARY OF THE INVENTION

The present invention broadly relates to a joystick control device comprising a movable stick, a movable yoke coupled to the stick, and a torque or force adjusting assembly including at least a spring which surrounds the stick, is compressible, and includes an end which exerts a force against the yoke and increase the force or torque required to move the stick.

In one embodiment, the spring is located in a housing and includes opposed upper and lower ends where the lower end is seated on the yoke and the torque or force adjusting assembly further includes a spring compression member in the housing which exerts a force against the upper end of the spring and compresses the spring in response to movement of the spring compression member.

The spring compression member includes at least one actuator member in the form of an arm extending outwardly from the spring compression member which, in one embodiment, extends generally horizontally outwardly from the spring compression member through an opening defined in a side wall of the housing while, in another embodiment, the arm extends generally vertically outwardly from the spring compression member through an opening defined in the top wall of the housing.

In one embodiment, the force or torque adjustment assembly further includes a lower spring retainer plate which is seated on the yoke and the lower end of the spring is retained in the spring retainer plate.

In one embodiment, the yoke is one of two yokes comprising a gimbal assembly contained within the housing and coupled to the stick assembly to allow the stick assembly to move therein. A pair of sensors are mounted to the ends of the yokes for generating an electrical output signal indicative of a position of the stick assembly and a switch on a base is activated when the stick assembly is sufficiently displaced to cause a lower end of the stick assembly to contact and close the switch. Another spring is located between the gimbal assembly and the base for biasing the gimbal assembly away from the switch. In this embodiment, the torque adjustment assembly described above is located in the housing above the gimbal assembly.

Thus, in accordance with the present invention, and in response to the application of a downward force against the arm of the spring compression member, the spring compression member is moved downwardly against the upper end of the spring which, in turn, compresses the spring and causes the lower end of the spring to exert a force against the lower spring retainer plate which, in turn, exerts a force against the yoke which, in turn, increases the force or torque required to move the stick. The magnitude of the force applied against the arm is adjustable to allow an adjustment in the magnitude of the torque or force required to move the stick.

There are other advantages and features that will be more readily apparent from the following description of the invention, the drawings, and the appended exemplary claims.

### BRIEF DESCRIPTION OF THE DRAWINGS

These and other features of the invention can best be understood by the following description of the accompanying drawings as follows:

FIG. 1 is a top perspective view of a joystick in accordance with the present invention;

FIG. 2 is an exploded perspective view of the joystick shown in FIG. 1;

FIG. 3 is a vertical cross-sectional view taken along the line 3-3 in FIG. 1 depicting the joystick in a light torque/force configuration;

FIG. 4 is a vertical cross-sectional view taken along the line 4-4 in FIG. 1 depicting the joystick in a heavy torque/force configuration; and

FIG. 5 is a partially broken phantom side perspective view of an alternate embodiment of a joystick in accordance with the present invention in a light torque/force configuration.

It is noted that the drawings of the invention are generally not to an exact scale. The drawings are schematic representations and are intended to depict only typical embodiments of the invention, and therefore should not be considered as limiting the scope of the invention. Additionally, identical numbers are used in different drawings to represent identical parts of the invention. The invention will be described with additional specificity and detail through the accompanying drawings.

### DETAILED DESCRIPTION

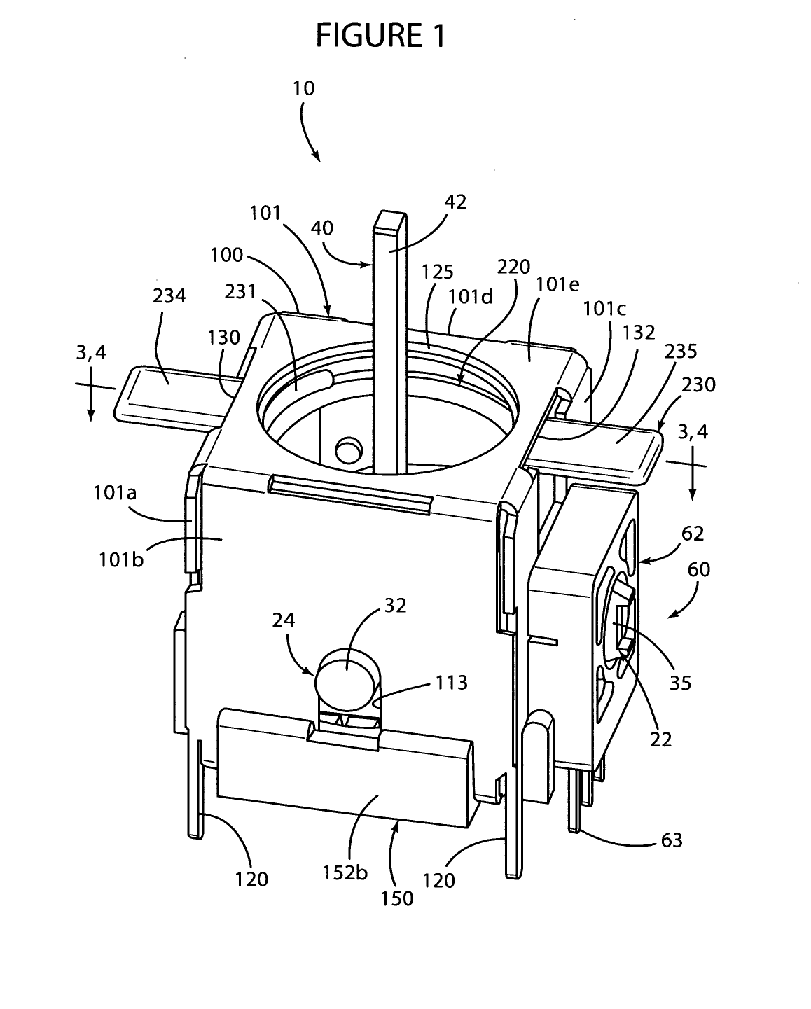

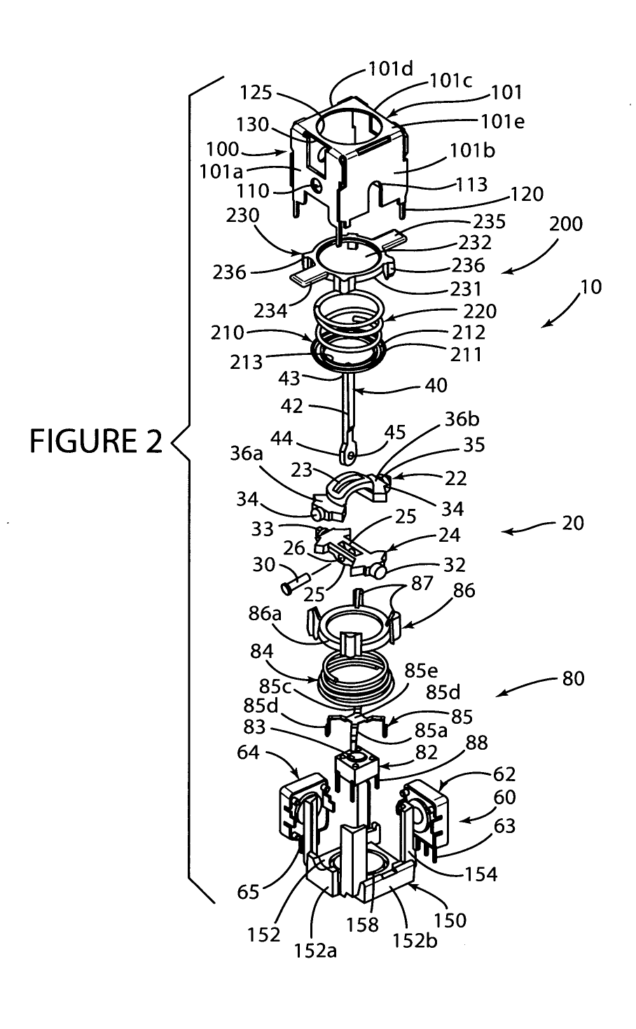

FIGS. 1-4 show one embodiment of a control device, pointing stick assembly or joystick 10 comprising a gimbal assembly 20 (FIG. 2), a stick assembly 40, a position sensor mechanism 60 (FIGS. 1 and 2), a switch assembly 80 (FIG. 2) and a force or torque adjustment assembly 200 all located in a housing 100. Joystick 10 can be mounted in a game controller as known in the art.

Gimbal assembly 20 (FIGS. 2, 3, and 4) is located in housing 100 and includes an active yoke 24 and a passive yoke 22 mounted over active yoke 24 in a relationship wherein the yokes 22 and 24 form a cross. Active yoke 24 is in the form of a bar defining a central, generally rectangularly-shaped slot or groove 25 (FIGS. 2, 3, 4), a generally cylindrically-shaped central aperture 26 (FIGS. 2, 3, 4) extending through the yoke 24 and groove 25 thereof in a direction generally normal to groove 25, and posts 32 and 33 extending outwardly from opposed ends of the yoke 24. Passive yoke 22 is in the form of a bar with an arc-shaped central portion defining a central, generally rectangularly-shaped slot or groove 23 (FIGS. 2, 3, 4) and posts 34 and 35 extending outwardly from opposed ends of yoke 22. Yoke 24 is positioned and extends under the arc-shaped central portion of yoke 22 in a relationship normal to yoke 22.

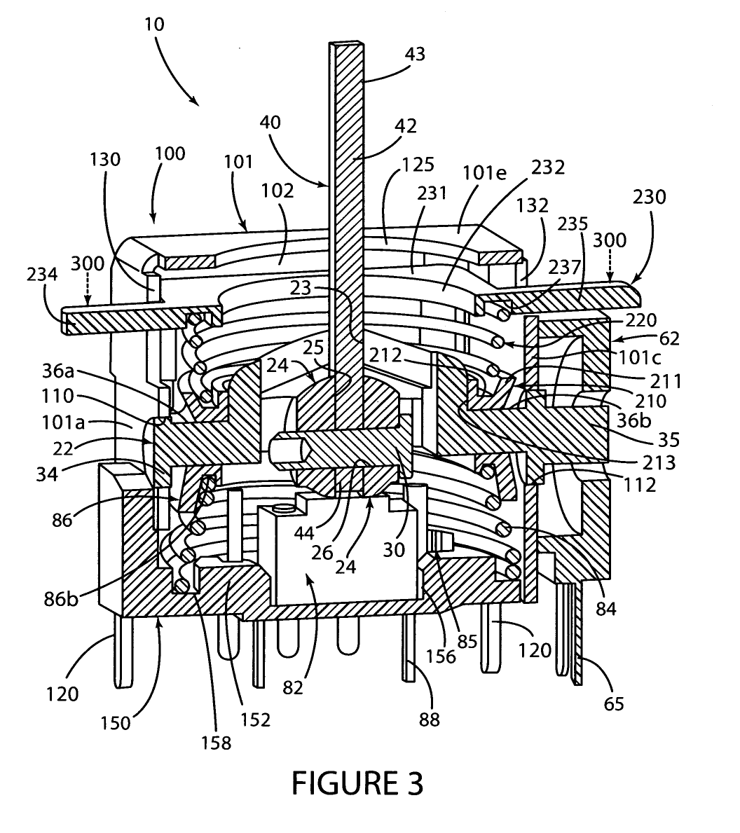

Housing 100 (FIGS. 1-4) includes a generally box-shaped upper housing or cover 101 and a base 150. Cover 101, which includes an open bottom, includes a plurality of vertical side walls 101a, 101b, 101c, and 101d, and a top horizontal wall or roof 101e together defining an interior cover cavity 102 (FIGS. 2 and 3). Side walls 101a and 101c define lower, generally circular, sensor apertures 110 and 112 respectively and top, generally rectangularly-shaped slots 130 and 132 respectively (FIGS. 1-4). Each of the side walls 101b and 101d defines lower, generally oval gimbal post apertures 113, only one of which is shown in FIGS. 1 and 2. A leg 120 (FIG. 2) extends downwardly from each of the lower corners of cover 101. Roof 101e defines a central circular aperture or opening 125.

Base 150 includes a generally flat bottom plate 152 (FIGS. 2, 3, and 4) and a leg 154 (FIG. 2) extending generally vertically upwardly from each of the corners of plate 152. A circumferentially extending, generally circular slot or recess 158 (FIGS. 2, 3, 4) is formed in the top interior bottom surface of bottom plate 152. A pair of lips 152a and 152b (FIG. 2) extend upwardly from adjacent peripheral edges of bottom plate 152.

Stick assembly 40 includes an elongate stick or shaft 42 with an upper end 43 protruding outside the housing 100 and a lower end 44 located inside the housing 100. A mounting and coupling aperture 45 (FIG. 2) is formed in and extends through lower end 44 of shaft 42. Stick assembly 40 is pivotally coupled to gimbal assembly 20 by sliding the lower end 44 of shaft 42 through the slots 23 and 25 in yokes 22 and 24 respectively into a relationship wherein aperture 45 in lower end 44 of shaft 42 is aligned with the aperture 26 in yoke 24 and then lockably inserting a hinge pin 30 through apertures 26 and 45 in yoke 24 and shaft 42 respectively.

Position sensor mechanism 60 (FIG. 2) includes two position sensors 62 and 64 mounted to the exterior of side walls 101c and 101d of housing 101 to allow the sensing of the rotational position of each of the yokes 22 and 24. Sensors 62 and 64 can be variable resistors or potentiometers. Yokes 22 and 24 are rotatably coupled to sensors 62 and 64 via respective yoke posts 35 and 33 of yokes 22 and 24 respectively which extend through the respective apertures in cover walls 101c and 101d respectively and into sensors 62 and 64 respectively. Sensor 62 has terminals 63 and sensor 64 has terminals 65.

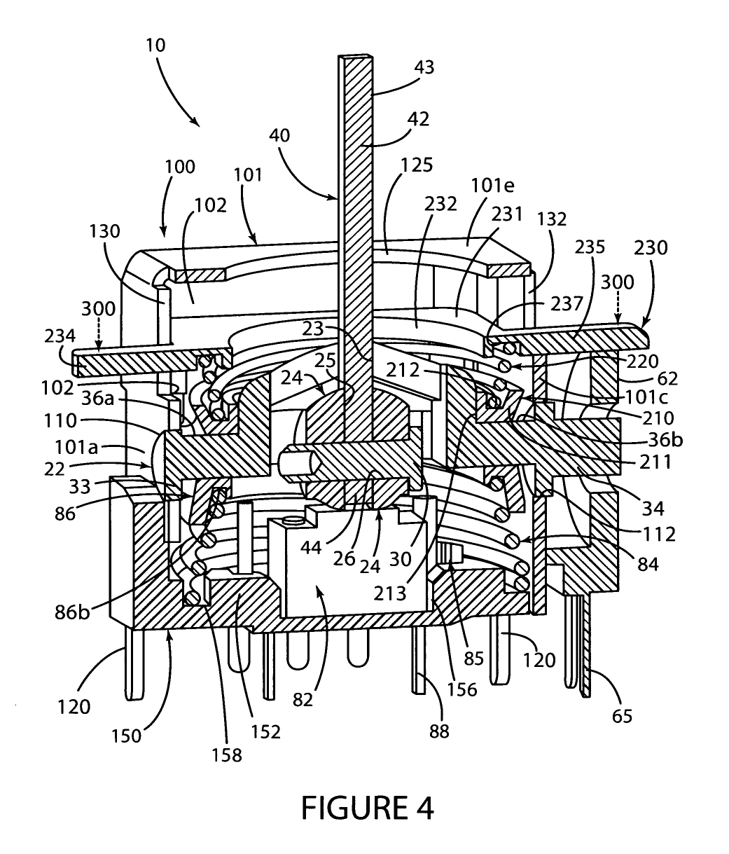

Switch assembly 80 (FIG. 2) is located in housing 100 and includes a momentary contact switch 82 which sits on top of plate 152 and includes a contact 83, a biasing means or lower compression spring 84, a hold spring 85, a spring retainer or hold member 86, and switch terminals 88 extending from the bottom of switch 82 into and through plate 152 (FIGS. 3, 4). Lower compression spring 84 is a helical spring which, in the embodiment shown, is generally cone-shaped and includes a lower end seated in the groove 158 (FIG. 2) defined in plate 152.

Hold spring 85 is in the form of a bracket including four legs 85a, 85b, 85c, and 85d extending around the circumference of a central hub or plate 85e at 90° increments. A foot extends generally normally downwardly from the terminal end of each of the legs 85a, 85b, 85c, and 85d.

The spring retainer member 86 includes a central ring 86a defining a bottom circumferential groove 86b (FIG. 3) and four guide or locating posts 87 extending around the exterior surface of ring 86a in an equidistant, spaced-apart relationship. The upper end of lower spring 84 is seated in the groove 86b in retainer member 86. The posts 87 are designed to cooperate and abut against the interior of the respective legs 154 of base 150 to guide and properly locate the spring retainer member 86 in base 150.

Position sensor mechanism 60 and switch assembly 80 are both located in housing 100 between gimbal assembly 20 and base plate 152.

In its assembled relationship, switch 82, compression spring 84, and hold spring 85 are all seated on base plate 152 of base 150. Switch 82 and hold spring 85 are both located inside the compression spring 84 in a relationship wherein the legs of hold spring 85 surround the switch 82 and the plate 85e of hold spring 85 overlies the contact 83 of the switch 82. Spring retainer member 86 is seated over the top end of spring 84 in a relationship wherein the posts 87 of retainer member 86 are seated against the plate 152 and the yoke 24 is seated on top of the ring 86a of spring retainer member 86. Yoke 22 is located above yoke 24. Lower end 44 of stick 42 is seated over the plate 85e of hold spring 85 which, in turn, is seated over the contact 83 of switch 82 to activate and/or close the switch 82 in response to movement of the stick 42.

Further details on the construction and operation of gimbal assembly 20, stick assembly 40, position sensor mechanism 60, switch assembly 80 and housing 100 are disclosed in U.S. Pat. No. 6,353,430 to Cheng et al. and currently assigned to CTS Corporation of Elkhart, Ind., the entire contents of which are herein incorporated by reference as though fully set forth herein.

### Force or Torque Adjustment Assembly

With continued reference to FIGS. 14, joystick 10 further comprises a force or torque adjustment assembly 200 which is located in housing 100 and, more specifically, inside the cover 101, and is designed to change or vary the amount of force or torque required to move the stick 42 as described in more detail below. Torque adjustment assembly 200 includes a bottom or lower ring plate 210, an upper helical compression spring 220, and a top or upper compression ring plate/holder/member 230 all located inside the cover 101. Torque adjustment assembly 220 is located and mounted in housing 100 above the gimbal assembly 20 and below the top wall 101e of cover 101.

Upper compression ring plate 230 includes a central ring 231 defining a central aperture 232, a pair of actuator arms or planks or members 234 and 235, and four corner guide or locating posts 236. Arms 234 are generally rectangularly-shaped and extend in an opposed relationship outwardly generally horizontally from diametrically opposed exterior sides of ring 231. Arms 234 and 235 extend through the respective grooves 130 and 132 defined in the respective side vertical walls 101a and 101c of housing cover 101. Posts 236 extend around the exterior periphery of ring 231 in equidistant, spaced-apart relationship. In the embodiment shown, two of the posts 236 are located on one side of arms 234 and 235 and the other two posts 236 are located on the other side of arms 234 and 235. Posts 236, in a manner similar to the posts 87 of spring retainer member 86, are designed to cooperate and abut against the interior of the respective legs 154 of base 150 to guide and properly locate the ring plate 230 for vertical up and down movement in housing 100.

Ring 231 additionally defines a circumferential groove 237 (FIGS. 3 and 4) formed in the bottom surface thereof. Upper compression ring plate 230 and, more specifically, the ring 231 thereof, is seated over the top end of spring 220 in a relationship wherein the top end of the spring 220 is seated in the groove 237 in ring 231.

Bottom ring plate 210 includes an interior circumferential surface defining a central aperture 213 and an exterior peripheral, circumferentially extending and upwardly and outwardly protruding lip 211 (FIGS. 3 and 4) which, in combination with a circumferentially extending groove 212 formed in the top surface of plate 210, defines a seat for the lower end of spring 220.

In the assembled relationship of torque adjustment assembly 200 in housing 100, stick 42 extends through the interior of each of the plates 210 and 230 and spring 220; plate 210 is seated on respective opposed ledges 36a and 36b (FIGS. 2, 3, and 4) defined by yoke 22 in a relationship wherein the arcuate central portion of yoke 22 protrudes through the central aperture of plate 210; the lower end of spring 220 is seated on plate 210; and the plate 230 is seated against the upper end of spring 220. Upper compression spring 220 is thus sandwiched and compressible between respective upper and lower ring plates 210 and 230 as described in more detail below.

A downward force, generally designated by the arrows 300 in FIGS. 3 and 4, is applied against the arms 234 and 235 of spring compression plate 230 by a suitable actuator assembly (not shown) located on the gaming controller box (not shown). Specifically, when downward force 300 is applied to arms 234 and 235 in response to manipulation by the user of the actuator assembly on the gaming controller box, the arms 234 and 235 and thus ring 231 of plate 230 are moved downwardly and exert a force against the top end of spring 210 seated in groove 237 of plate 230 which, in turn, compresses the spring 220 which, in turn, causes an increase in the spring force applied by the lower end of spring 220 against bottom ring plate 210 which, in turn, causes an increase in the force applied by plate 210 against yoke 22 and then yoke 24 of gimbal assembly 20. The additional force on yokes 22 and 24, and thus gimbal assembly 20, then correspondingly increases the force or torque which a user must apply to stick 42 to move the stick 42.

FIG. 3 shows the joystick 10 in a light torque configuration in which the plate 210 has been pushed only partially vertically downwardly in housing 100 so as to cause only a partial compression of spring 200 which, in turn, results in the application of only a partial force against gimbal assembly 20 which, in turn, will then require the application of only a light torque or force on stick 42 to move stick 42.

FIG. 4 on the other hand shows the joystick 10 in a heavy torque/force configuration where the plate 230 has been pushed vertically downwardly further in the housing 100 and the spring 220 has been fully compressed which, in turn, results in the application of an enhanced force against gimbal assembly 20 which, in turn, will require the application of a heavy torque or force to move the stick 42.

It is understood of course that when force 300 is retracted, arms 234 and 235 and thus upper plate 230 move upwardly, thus releasing upper compression spring 220 and decreasing the downward force applied against yokes 22 and 24. The reduced force on yokes 22 and 24 in turn decreases the force or torque that must be applied by a user to move stick 42.

Although not shown in any of the drawings or described in any detail herein, it is understood that the actuator assembly associated with the game controller will be adapted to allow the position of plate 230 to be adjusted to any one or more intermediate positions between fully extended and fully compressed spring configurations depending upon the torque or force desired for stick 42.

### Alternative Embodiment

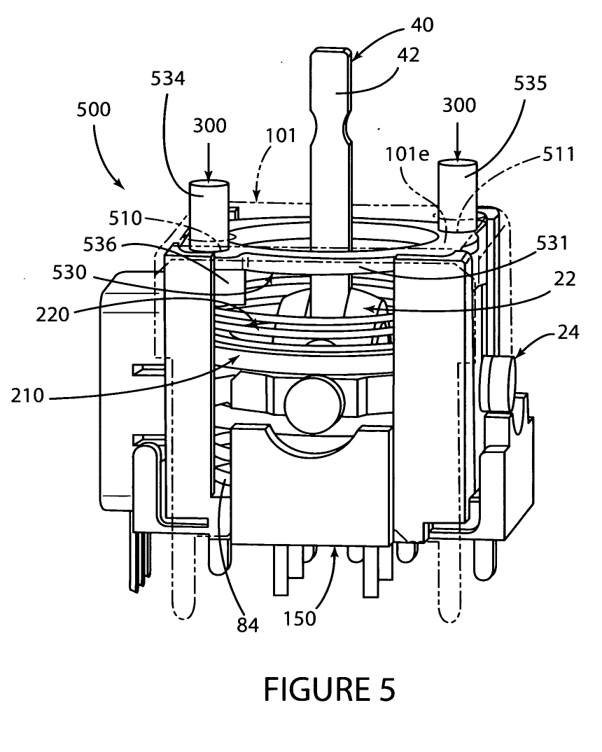

An alternative embodiment of a joystick 500 in accordance with the present invention is shown in FIG. 5. Joystick 500 is identical to joystick 10 except as otherwise described below, and thus the description above of the structure and operation of the various elements of joystick 10 applies to joystick 500 and is thus incorporated herein by reference.

Joystick 500 differs from joystick 10 in that joystick 500 incorporates an alternate compression ring member/holder embodiment 530 in which the arms 234 and 235 of the compression ring member embodiment 230 of joystick 10 have been substituted with a pair of actuator pins or arms or members 534 and 535 which extend generally vertically outwardly and upwardly away from opposed corners of the top surface of the ring 531 of compression ring member 530 and four posts 536 identical in structure to posts 236 of ring member 230 of joystick 10 protrude generally vertically downwardly from the bottom surface of the ring 531 of compression ring member 530. Although FIG. 5 shows only one of the posts 536 which, in the embodiment shown, is positioned on ring 531 directly below pin 534, it is understood that another post 536 is positioned on ring 536 directly below pin 535.

Specifically, and as shown in FIG. 5, pins 534 and 535 are designed to protrude through respective openings 510 and 511 defined in the roof 101e of cover 101 and the bottom face of each of the posts 536 is designed to be seated against the top end of the compression spring 220.

The operation of joystick 500 is the same as the operation of joystick 10 and thus the earlier description thereof with respect to joystick 10 is incorporated herein by reference except as otherwise described below.

In summary, when a downward force 300 is applied to actuator pins 534 and 535 in response to the manipulation by the user of a suitable actuator control assembly on a game controller, the compression spring member 530 is pushed down which causes the posts 536 to exert a force against the top end of compression spring 220 which, in turn, compresses spring 220 which, as described above in great detail with respect to joystick 10, in turn increases the downward force applied to the gimbal assembly 20 and, more specifically, to yokes 22 and 24. The additional force on yokes 22 and 24 increases the force or torque which a user must exert on stick 42 to move the stick 42. FIG. 5 shows joystick 500 in a heavy torque or force configuration with the spring 220 in a substantially fully compressed configuration.

### Conclusion

While the invention has been taught with specific reference to the embodiments shown, a person of ordinary skill in the art will recognize that changes can be made in form and detail without departing from the spirit and the scope of the invention. The described embodiments are thus to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A joystick control device comprising a movable stick, a movable yoke coupled to the stick, and a spring surrounding the stick, the spring being compressible and including an end which exerts a force against the yoke and increases the force or torque required to move the stick.

2. The joystick control device of claim 1, wherein a lower end of the spring is seated on and exerts a force against the yoke.

3. The joystick control device of claim 2, wherein the spring includes an upper end, the joystick control device further comprising a spring compression member adapted to exert a force against the upper end of the spring and compress the spring.

4. The joystick control device of claim 3, wherein the spring compression member includes at least one actuator member.

5. The joystick control device of claim 4 wherein the actuator member is an arm extending outwardly from the spring compression member.

6. The joystick control device of claim 5, wherein the arm extends generally horizontally outwardly from the spring compression member.

7. The joystick control device of claim 5, wherein the arm extends generally vertically outwardly from the spring compression member.

8. The joystick control device of claim 5., wherein the spring compression member includes a ring seated against the upper end of the spring and the arm extends from the ring.

9. The joystick control device of claim 2 further comprising a spring retainer plate seated on the yoke, the lower end of the spring being retained in the spring retainer plate.

10. The joystick control device of claim 1 wherein the yoke, the spring, and another spring are all located in a housing, the spring being located above the yoke and the other spring being located below the yoke.

11. A joystick control device comprising a movable stick, a movable yoke coupled to the stick, a compressible spring including opposed first and second ends, and a spring compression member, wherein movement of the spring compression member in response to the application of a force thereto compresses the spring and causes the spring to exert a force against the movable yoke and increase the force or torque required to move the stick.

12. The joystick control device of claim 11, wherein the spring compression member includes a ring seated against the first end of the spring and an actuator arm, the force being applied to the arm.

13. The joystick control device of claim 11 further comprising a spring retainer member, the second end of the spring being seated in the spring retainer member and the spring retainer member being seated on the yoke.

14. A joystick control device comprising:
a housing;
a movable stick in the housing;
a yoke in the housing, one end of the stick being coupled to the yoke;
a spring in the housing and surrounding the stick, the spring including opposed first and second ends;
a spring compression member in the housing and seated against the first end of the spring; and
a spring retainer member in the housing and seated on the yoke, the second end of the spring being retained in the spring retaining member whereby downward movement of the spring compression member in response to the application of a force thereto exerts a force against the first end of the spring to compress the spring and cause the second end of the spring and the spring retainer member to exert a force against the yoke and increase the force required to move the stick.

15. The joystick control device of claim 14, wherein the spring compression member includes a ring seated against the first end of the spring and an actuator arm extending outwardly from the ring through an opening defined in the housing, the force being applied to the actuator arm.

16. The joystick control device of claim 14 wherein another spring is located in the housing below the yoke.

17. A control device, comprising:
a housing;
a stick assembly mounted in the housing, the stick assembly having an end extending from the housing and another end in the housing;
a gimbal assembly contained within the housing, the gimbal assembly including:
a first and a second yoke coupled to the stick assembly for allowing the stick assembly to move therein, the first and second yokes each having a pair of ends; and
a pair of sensors mounted to the ends of the first and second yokes for generating an electrical output signal indicative of a position of the stick assembly;
a base;
a switch on the base being activated when the stick assembly is sufficiently displaced to cause the other end of the stick assembly to contact and close the switch;
a first spring located between the gimbal assembly and the base for biasing the gimbal assembly away from the switch; and
a torque adjustment assembly located in the housing above the gimbal assembly and including a second spring compressible in response to the application of a force thereto and adapted to exert a force against the gimbal assembly and change the magnitude of force required to move the stick.

18. The control device of claim 17, wherein the torque adjustment assembly includes an upper compression member in the housing movable in the direction of the second spring to compress the spring.

19. The control device of claim 18, wherein the upper compression member includes an actuator arm which protrudes through an opening in the housing, the force being applied to the arm.

20. The control device of claim 19, wherein the torque adjustment assembly includes a retainer plate seated on the gimbal assembly, the second spring including a lower end seated in the retainer plate.
